(19) United States
(12) Patent Application Publication
(10) Pub. No.: US 2009/0002359 A1
(43) Pub. Date: Jan. 1, 2009

(54) SOURCE DRIVER, ELECTRO-OPTICAL DEVICE, PROJECTION-TYPE DISPLAY DEVICE, AND ELECTRONIC INSTRUMENT

(75) Inventor: Tsuyoshi TAMURA, Suwagun Haramura (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/146,834

(22) Filed: Jun. 26, 2008

(30) Foreign Application Priority Data
Jun. 29, 2007 (JP) 2007-172043

(51) Int. Cl. G06F 3/038

(52) U.S. Cl. 345/213

(57) ABSTRACT

A source driver that drives a source line of an electro-optical device includes a receiving circuit that receives image data, a vertical synchronization timing, or a horizontal synchronization timing through a transmission line that transmits the image data, the vertical synchronization timing, or the horizontal synchronization timing, and a source line driver circuit that drives the source line based on the image data in synchronization with the vertical synchronization timing or the horizontal synchronization timing. The receiving circuit compares received data that indicates the image data, the vertical synchronization timing, or the horizontal synchronization timing with given vertical synchronization timing designation data or given horizontal synchronization timing designation data. The vertical synchronization timing or the horizontal synchronization timing is designated by the received data that coincides with the vertical synchronization timing designation data or the horizontal synchronization timing designation data.

Japanese Patent Application No. 2007-172043 filed on Jun. 29, 2007, is hereby incorporated by reference in its entirety.

### BACKGROUND OF THE INVENTION

The present invention relates to a source driver, an electro-optical device, a projection-type display device, an electronic instrument, and the like.

The size of image data has been increased along with an increase in screen size and definition of a liquid crystal display (LCD) panel. Therefore, an increase in image data transfer rate of a source driver (driver circuit) that drives an LCD panel has been desired. A source driver aimed at increasing the image data transfer rate utilizes a high-speed serial transfer method using differential signal lines. The source driver receives image data and a display timing signal from a host or a display controller.

As disclosed in JP-A-2005-257854, for example, a source driver utilizing the high-speed serial transfer method has a differential interface (I/F) that transfers signals through differential signal lines. In JP-A-2005-257854, the display timing is designated by a timing controller. JP-A-2005-165273 discloses technology in which a dedicated clock signal is provided and packetized data is transferred, and JP-A-2002-175065 discloses technology in which a vertical synchronization signal and a horizontal synchronization signal are converted into differential data indicated by differential signals transmitted through differential signal lines, for example. JP-A-2005-326805 discloses technology in which image data and a clock signal are encoded using a serial protocol, for example.

A signal line through which a vertical synchronization signal or a horizontal synchronization signal is transferred may be driven using a complementary metal-oxide-semiconductor (CMOS) signal, and the vertical synchronization signal or the horizontal synchronization signal may be transmitted using a CMOS signal utilizing a system differing from that of differential data. Alternatively, data relating to a vertical synchronization signal, a horizontal synchronization signal, a data enable signal, or a parity signal may be set in bits added to image data.

However, the amount of data to be transmitted increases when transferring packetized data or adding bits to image data. When converting a vertical synchronization signal or the like into differential data, a circuit that converts the vertical synchronization signal or the like into differential data is required in addition to a circuit that converts image data into differential data. When transferring a vertical synchronization signal or the like utilizing a system differing from that of differential data, it is difficult to adjust the difference in timing between a CMOS signal and a differential signal. This may cause an electro magnetic interference (EMI) or increase the number of terminals to which the vertical synchronization signal or the like is input.

The invention was conceived in view of the above-described technical problems. An object of the invention is to provide a source driver that receives a large amount of image data while minimizing an increase in the amount of data to be transferred and suppressing an increase in the number of terminals, an electro-optical device, a projection-type display device, and an electronic instrument including the source driver.

### SUMMARY

According to one aspect of the invention, there is provided a source driver that drives a source line of an electro-optical device, the source driver comprising:

a receiving circuit that receives image data, a vertical synchronization timing, or a horizontal synchronization timing through a transmission line that transmits the image data, the vertical synchronization timing, or the horizontal synchronization timing; and

a source line driver circuit that drives the source line based on the image data in synchronization with the vertical synchronization timing or the horizontal synchronization timing,

the receiving circuit comparing received data that indicates the image data, the vertical synchronization timing, or the horizontal synchronization timing with given vertical synchronization timing designation data or given horizontal synchronization timing designation data; and

the vertical synchronization timing or the horizontal synchronization timing being designated by the received data that coincides with the vertical synchronization timing designation data or the horizontal synchronization timing designation data.

According to another aspect of the invention, there is provided an electro-optical device comprising the above source driver.

According to another aspect of the invention, there is provided a projection-type display device comprising the above source driver.

According to another aspect of the invention, there is provided an electronic instrument comprising the above source driver.

### BRIEF DESCRIPTION OF THE SEVERAL VIEWS OF THE DRAWING

FIG. 1 is a view showing an outline of the configuration of a liquid crystal device according to one embodiment of the invention.

FIG. 2 is a block diagram showing a configuration example of a display controller shown in FIG. 1.

FIG. 3 is a view illustrative of grayscale data in a super-white area and a super-black area according to one embodiment of the invention.

FIG. 4 is a block diagram showing the main portion of the configuration of a source driver shown in FIG. 1.

FIG. 5 is a view illustrative of data transfer through differential signal lines.

FIG. 6 is a timing diagram showing an operation example of a vertical synchronization timing comparison circuit.

FIG. 7 is a timing diagram showing an operation example of a horizontal synchronization timing comparison circuit.

FIGS. 8A, 8B, and 8C are views illustrative of the data format of differential data according to one embodiment of the invention transmitted through differential signal lines.

FIG. 9 shows an input example of differential data shown in FIGS. 8A to 8C.

FIG. 10 is a view schematically showing the configuration of an active matrix type liquid crystal device according to one embodiment of the invention.

FIG. 11 is a view showing an outline of another configuration of an active matrix type liquid crystal device according to one embodiment of the invention.

FIG. 12 is a view showing a configuration example of a gate driver shown in FIG. 10 or 11.

FIG. 13 is a view showing a detailed configuration example of a source driver shown in FIG. 10 or 11.

FIG. 14 is a view showing an operation example of a demultiplexer shown in FIG. 13.

FIG. 15 is a circuit diagram showing a configuration example of a demultiplexer of an LCD panel.

FIG. 16 is a view illustrative of the operation of the demultiplexer shown in FIG. 15.

FIG. 17 is a block diagram showing a configuration example of a source driver according to a modification.

FIG. 18 is a block diagram showing a configuration example of a projection-type display device according to one embodiment of the invention.

FIG. 19 is a schematic view showing the main portion of a projection-type display device.

FIG. 20 is a block diagram showing a configuration example of a portable telephone according to one embodiment of the invention.

### DETAILED DESCRIPTION OF THE EMBODIMENT

Several aspects of the invention may provide a source driver that receives a large amount of image data while minimizing an increase in the amount of data to be transferred and suppressing an increase in the number of terminals, an electro-optical device, a projection-type display device, and an electronic instrument including the source driver.

According to one embodiment of the invention, there is provided a source driver that drives a source line of an electro-optical device, the source driver comprising:

a receiving circuit that receives image data, a vertical synchronization timing, or a horizontal synchronization timing through a transmission line that transmits the image data, the vertical synchronization timing, or the horizontal synchronization timing; and

a source line driver circuit that drives the source line based on the image data in synchronization with the vertical synchronization timing or the horizontal synchronization timing,

the receiving circuit comparing received data that indicates the image data, the vertical synchronization timing, or the horizontal synchronization timing with given vertical synchronization timing designation data or given horizontal synchronization timing designation data; and

the vertical synchronization timing or the horizontal synchronization timing being designated by the received data that coincides with the vertical synchronization timing designation data or the horizontal synchronization timing designation data.

According to this embodiment, the number of terminals to which a vertical synchronization signal and a horizontal synchronization signal are input can be reduced without increasing the circuit scale of an I/F circuit of the source driver by transferring the vertical synchronization timing designation data or the horizontal synchronization timing designation data through the same transmission path as that of the grayscale data.

In the source driver according to this embodiment,

the source driver may include a first counter that starts a count operation after the receiving circuit has detected that the received data coincides with the vertical synchronization timing designation data,

the first counter may mask a comparison result between the received data and the vertical synchronization timing designation data until a count value of the first counter reaches a first count value equal to or less than a data reception count value corresponding to a number of scan lines.

According to this embodiment, a situation in which the vertical synchronization timing is erroneously detected due to noise superimposed on the transmission path can be prevented. Moreover, power consumption can be reduced by omitting an unnecessary comparison process.

In the source driver according to this embodiment,

the source driver may include a second counter that starts a count operation after the receiving circuit has detected that the received data coincides with the horizontal synchronization timing designation data,

the second counter may mask a comparison result between the received data and the horizontal synchronization timing designation data until a count value of the second counter reaches a second count value equal to or less than a data reception count value corresponding to a number of horizontal pixels.

According to this embodiment, a situation in which the horizontal synchronization timing is erroneously detected due to noise superimposed on the transmission path can be prevented. Moreover, power consumption can be reduced by omitting an unnecessary comparison process.

In the source driver according to this embodiment,

the vertical synchronization timing may be designated using the received data on condition that the received data has successively coincided with the vertical synchronization timing designation data a given number of times.

In the source driver according to this embodiment,

the horizontal synchronization timing may be designated using the received data on condition that the received data has successively coincided with the horizontal synchronization timing designation data a given number of times.

According to this embodiment, a situation in which the vertical synchronization timing or the horizontal synchronization timing is erroneously detected can be further suppressed.

In the source driver according to this embodiment,

data transmitted through the transmission line may include an image data field that designates the image data and flag fields that designate the vertical synchronization timing, the horizontal synchronization timing, and parity data.

In the source driver according to this embodiment,

the flag fields may include an area that designates a command for controlling the source driver.

According to this embodiment, the vertical synchronization timing or the horizontal synchronization timing can be detected by a simple configuration and the command for the source driver can be set while reducing the number of terminals. Therefore, an increase in the amount of data to be transferred can be minimized.

In the source driver according to this embodiment,

the source driver may include a vertical synchronization designation data setting register, the vertical synchronization timing designation data being set in the vertical synchronization designation data setting register,

the receiving circuit may compare the received data with a value set in the vertical synchronization designation data setting register.

According to this embodiment, since arbitrary data can be designated as the vertical synchronization timing designation data, a flexible source driver can be provided.

In the source driver according to this embodiment,

the source driver may include a horizontal synchronization designation data setting register, the horizontal synchronization timing designation data being set in the horizontal synchronization designation data setting register,

the receiving circuit may compare the received data with a value set in the horizontal synchronization designation data setting register.

According to this embodiment, since arbitrary data can be designated as the horizontal synchronization timing designation data, a flexible source driver can be provided.

In the source driver according to this embodiment,

the vertical synchronization timing designation data may be data in a super-white area or a super-black area, all bits of the data in the super-white area or the super-black area being “0” or “1”.

According to this embodiment, the vertical synchronization timing can be designated by a simple configuration without providing a terminal.

In the source driver according to this embodiment,

the horizontal synchronization timing designation data may be data in a super-white area or a super-black area, all bits of the data in the super-white area or the super-black area being “0” or “1”.

According to this embodiment, the horizontal synchronization timing can be designated by a simple configuration without providing a terminal.

According to another embodiment of the invention, there is provided an electro-optical device comprising:

a plurality of gate lines;

a plurality of source lines;

a plurality of pixels, each of the plurality of pixels being specified by a corresponding gate line among the plurality of gate lines and a corresponding source line among the plurality of source lines;

a gate driver that scans the plurality of gate lines; and

one of the above source drivers that drives the plurality of source lines.

According to another embodiment of the invention, there is provided an electro-optical device comprising one of the above source drivers.

According to this embodiment, an electro-optical device can be provided to which a source driver that receives a large amount of image data while minimizing an increase in the amount of data to be transferred and suppressing an increase in the number of terminals is applied.

According to another embodiment of the invention, there is provided a projection-type display device comprising:

the above electro-optical device;

a light source that emits light that enters the electro-optical device; and

projection means that projects light emitted from the electro-optical device.

According to another embodiment of the invention, there is provided a projection-type display device comprising one of the above source drivers.

According to this embodiment, a projection-type display device can be provided to which a source driver that receives a large amount of image data while minimizing an increase in the amount of data to be transferred and suppressing an increase in the number of terminals is applied.

According to another embodiment of the invention, there is provided an electronic instrument comprising the above electro-optical device.

According to another embodiment of the invention, there is provided an electronic instrument comprising:

the above electro-optical device; and

means that supplies image data to the electro-optical device.

According to another embodiment of the invention, there is provided an electronic instrument comprising one of the above source drivers.

According to this embodiment, an electronic instrument can be provided to which a source driver that receives a large amount of image data while minimizing an increase in the amount of data to be transferred and suppressing an increase in the number of terminals is applied.

Embodiments of the invention are described in detail below with reference to the drawings. Note that the embodiments described below do not in any way limit the scope of the invention laid out in the claims. Note that all elements of the embodiments described below should not necessarily be taken as essential requirements for the invention.

1. Outline of Liquid Crystal Device

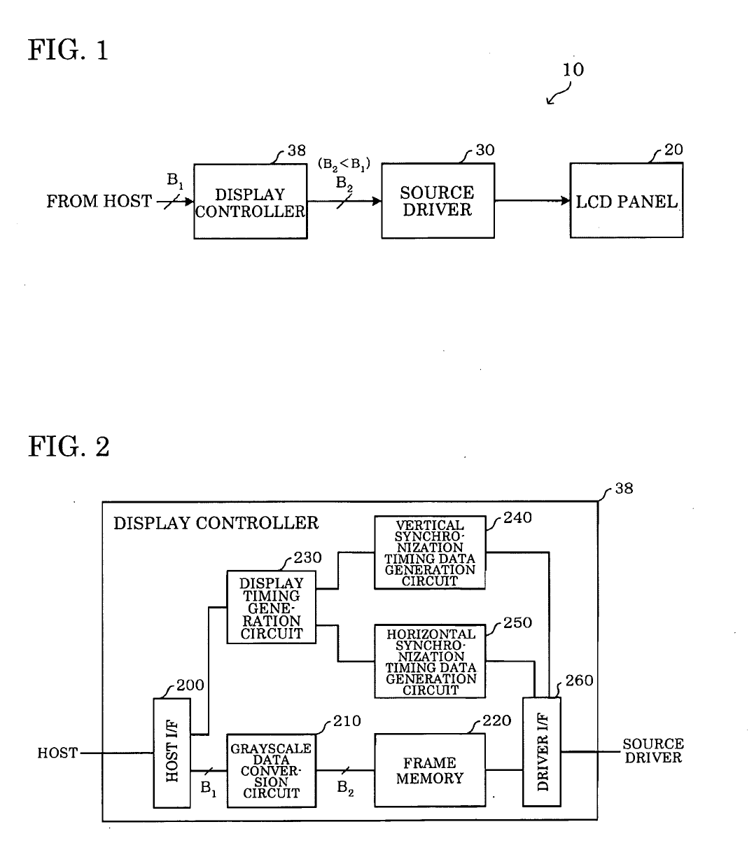

FIG. 1 shows an outline of the configuration of a liquid crystal device according to one embodiment of the invention.

The liquid crystal device 10 includes a display controller 38, a source driver 30, and an LCD panel 20. The display controller 38 receives grayscale data (image data) generated by a host (not shown), processes the grayscale data, and supplies the processed grayscale data to the source driver 30 at a display timing. The source driver 30 drives a plurality of source lines of the LCD panel 20 based on the grayscale data from the display controller 38 in synchronization with the display timing of the display controller 38. The LCD panel 20 includes a plurality of gate lines and a plurality of source lines. A drive signal is applied to pixels connected to the gate line selected by a gate driver (not shown) through the source lines.

The display controller 38 receives grayscale data having a data size corresponding to one pixel (or one dot that forms one pixel) of B₁ bits (B₁ is an integer equal to or larger than two), and supplies grayscale data having a data size corresponding to one pixel (or one dot that forms one pixel) of B₂ bits (1<B₂<B₁, B₂ is an integer equal to or larger than two) to the source driver 30. Specifically, the source driver 30 drives the source lines of the LCD panel 20 based on the grayscale data having a data size corresponding to one pixel (or one dot that forms one pixel) of B₂ bits.

Therefore, the display controller 38 can convert the B₁-bit grayscale data designated by the host to the source driver 30 into another piece of grayscale data so that display unevenness and the like due to the manufacturing variation in the LCD panel 20 can be eliminated. Specifically, it suffices that the display controller 38 select one of 2^{B2} (<2^{B1}) grayscales from the grayscale data of 2^{B1} grayscales corresponding to the characteristics of the LCD panel 20. Therefore, the host and the source driver 30 can be operated without taking into consideration the variation in characteristic of the LCD panel 20.

In this embodiment, the display controller 38 and the source drivers 30 exchange grayscale data and display timing data as differential data through differential signal lines. This makes it unnecessary to take into account a difference in timing as compared with the case of exchanging the grayscale data and the display timing through different paths. Moreover, the cause of EMI can be reduced while reducing the number of terminals of the source driver 30 and the display controller 38.

FIG. 2 is a block diagram showing a configuration example of the display controller 38 shown in FIG. 1.

The display controller 38 includes a host interface (hereinafter abbreviated as “I/F”) 200, a grayscale data conversion circuit 210, a frame memory 220, a display timing generation circuit 230, a vertical synchronization timing data generation circuit 240, a horizontal synchronization timing data generation circuit 250, and a driver I/F 260.

The host I/F 200 performs an interface process on a signal transmitted (input and output) through a signal line connected to the host (not shown) and the display controller 38.

The grayscale data conversion circuit 210 converts grayscale data having a data size corresponding to one pixel (or one dot that forms one pixel) of B₁ bits into grayscale data having a data size corresponding to one pixel (or one dot that forms one pixel) of B₂ bits. The grayscale data conversion circuit 210 converts the input B₁-bit grayscale data into given B₂-bit grayscale data based on instructions from the host or the like.

The frame memory 220 stores the grayscale data converted by the grayscale data conversion circuit 210. The frame memory 220 stores the grayscale data corresponding to at least one vertical scan, and sequentially outputs the grayscale data to the source driver 30 through differential signal lines.

The display timing generation circuit 230 generates a display timing of an image output from the display controller 38 to the source driver 30 based on a vertical synchronization timing and a horizontal synchronization timing designated by the host through the host I/F 200.

The vertical synchronization timing data generation circuit 240 generates vertical synchronization timing designation data determined in advance corresponding to the vertical synchronization timing among the display timings generated by the display timing generation circuit 230. The B₁-bit grayscale data corresponding to one pixel (or one dot) that is not converted into B₂-bit grayscale data corresponding to one pixel (or one dot) by the grayscale data conversion circuit 210 is assigned to the vertical synchronization timing designation data. The grayscale data in a super-black area (super-white area) of which all bits are “0” or “1” and which affects the image quality of the display image may be used as the vertical synchronization timing designation data.

The horizontal synchronization timing data generation circuit 250 generates horizontal synchronization timing designation data determined in advance corresponding to the horizontal synchronization timing among the display timings generated by the display timing generation circuit 230. The B₁-bit grayscale data corresponding to one pixel (or one dot) that is not converted into B₂-bit grayscale data corresponding to one pixel (or one dot) by the grayscale data conversion circuit 210 is assigned to the horizontal synchronization timing designation data. The grayscale data in the super-black area (super-white area) of which all bits are “0” or “1” and which affects the image quality of the display image may be used as the horizontal synchronization timing designation data. When using the grayscale data in the super-black area as the vertical synchronization timing designation data, the grayscale data in the super-white area is used as the horizontal synchronization timing designation data. When using the grayscale data in the super-white area as the vertical synchronization timing designation data, the grayscale data in the super-black area is used as the horizontal synchronization timing designation data.

The driver I/F 260 transmits the vertical synchronization timing designation data, the horizontal synchronization timing designation data, and the grayscale data read from the frame memory 220 through differential signal lines connected to the source driver 30.

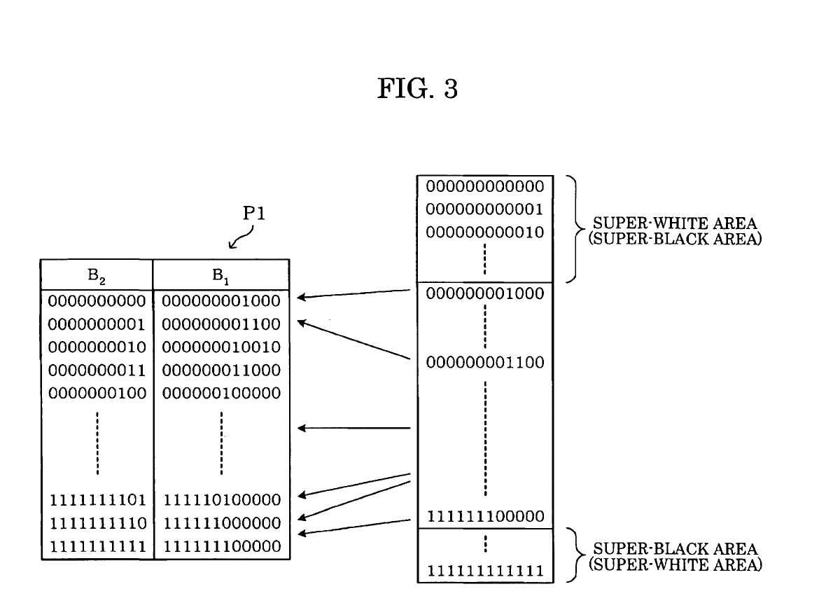

FIG. 3 is a view illustrative of the grayscale data in the super-white area and the super-black area according to this embodiment. FIG. 3 shows an example in which B₁ is “12” and B₂ is “10”.

The display controller 38 adjusts a variation in the liquid crystal element of the LCD panel 20 and the optical characteristics corresponding to each product. As indicated by an assignment table P1, the grayscale data conversion circuit 210 outputs the grayscale data having a data size corresponding to one pixel (or one dot) of B₂ bits, and the B₁-bit grayscale data before conversion is assigned to the B₂-bit grayscale data. The assignment method is designated by a value set in a control register by the host or the like corresponding to the characteristics of the LCD panel 20.

Since B₁ is larger than B₂, only the corresponding B₁-bit grayscale data is assigned to the B₂-bit grayscale data. The vertical synchronization timing data generation circuit 240 and the horizontal synchronization timing data generation circuit 250 utilize the B₁-bit grayscale data which is not assigned to the B₂-bit grayscale data as the vertical synchronization timing designation data and the horizontal synchronization timing designation data.

In particular, the grayscale data that achieves the best performance of the LCD panel 20 is not selected according to the characteristic adjustment assignment table P1. Specifically, the image quality is affected to a small extent due to the difference in grayscale data in the super-white area and the super-black area, and the grayscale data in the super-white area and the super-black area is rarely used. For example, when the grayscale data of which all bits are “0” or “1” is selected in order to correct a variation in color components corresponding to one pixel, the grayscale correction range is limited. Therefore, the grayscale data in the super-black area (super-white area) of which all bits are “0” or “1” is not used.

In this embodiment, the grayscale data in the super-black area (super-white area) is used as the vertical synchronization timing designation data or the horizontal synchronization timing designation data, and the display timing is supplied to the source driver 30 through the same transmission path as that of the grayscale data. As a result, the number of terminals through which the vertical synchronization signal and the horizontal synchronization signal are input and output can be reduced without increasing the circuit scale of the differential I/Fs of the source driver 30 and the display controller 38.

2. Outline of Source Driver

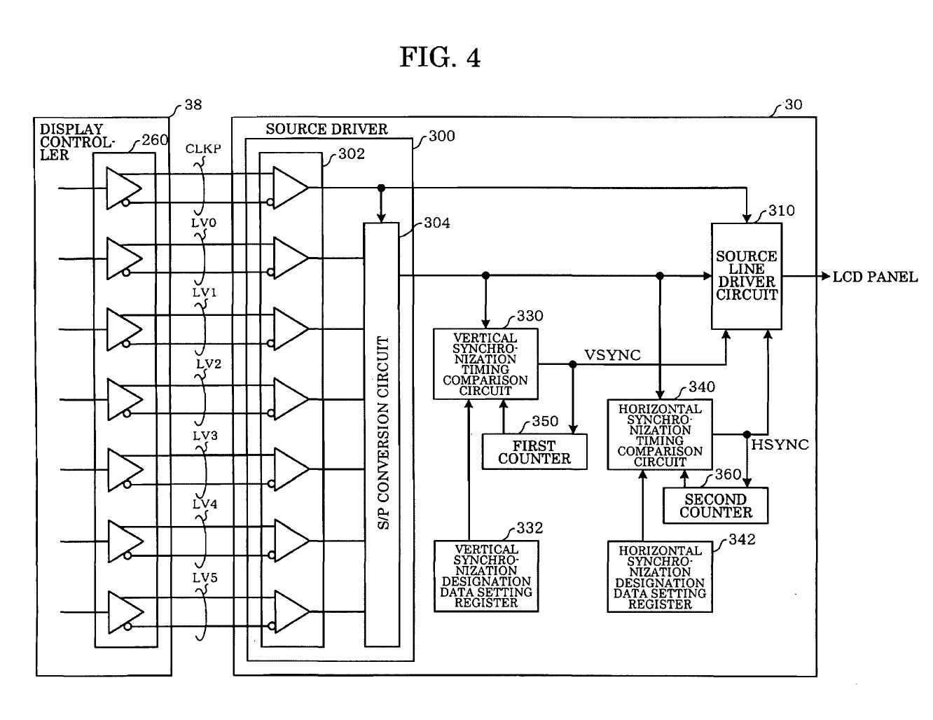

FIG. 4 is a block diagram showing the main portion of the configuration of the source driver 30 shown in FIG. 1.

In FIG. 4, the display controller 38 and the source driver 30 are connected through a pair of differential signal lines through which a dot clock signal is transmitted and six pairs of differential signal lines through which six-bit grayscale data is transmitted.

The source driver 30 includes a receiving circuit 300 and a source line driver circuit 310. The receiving circuit 300 receives the grayscale data, the vertical synchronization timing, or the horizontal synchronization timing through the differential signal lines (transmission line) that transmit the grayscale data, the vertical synchronization timing, or the horizontal synchronization timing. The source line driver circuit 310 drives the source line of the LCD panel 20 based on the grayscale data received by the receiving circuit 300 in synchronization with the vertical synchronization timing or the horizontal synchronization timing received by the receiving circuit 300.

The receiving circuit 300 includes a receiver circuit 302 and a serial/parallel (S/P) conversion circuit 304. The receiver circuit 302 receives differential signals transmitted from a transmitter of the driver I/F 260 of the display controller 38 through the differential signal lines. The S/P conversion circuit 304 converts serial data received by the receiver circuit 302 into parallel data. Specifically, the S/P conversion circuit 304 converts the data received by the receiver circuit 302 into parallel data using a clock signal received by the receiver circuit 302.

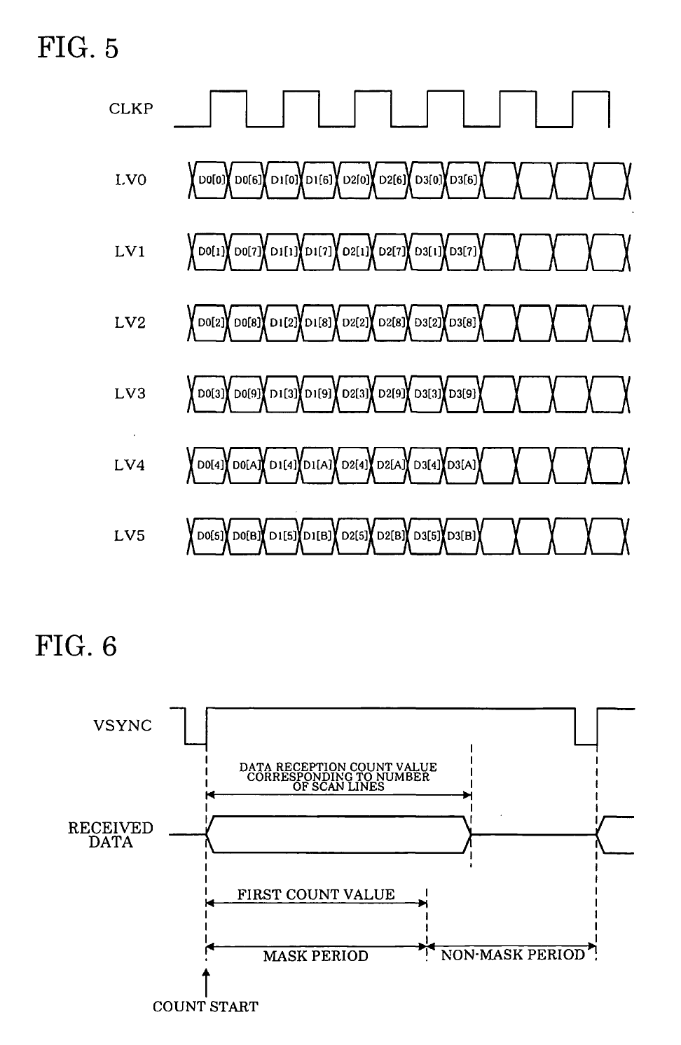

As shown in FIG. 5, the receiver circuit 302 receives the six-bit grayscale data at the rising edge and the falling edge of the dot clock signal, and the S/P conversion circuit 304 converts the grayscale data into 12-bit parallel data, for example.

The source driver 30 compares the data received by the receiving circuit 300 with given vertical synchronization timing designation data or given horizontal synchronization timing designation data. The vertical synchronization timing or the horizontal synchronization timing is designated by the received data that coincides with the vertical synchronization timing designation data or the horizontal synchronization timing designation data. The source driver 30 may include a vertical synchronization timing comparison circuit 330 and a horizontal synchronization timing comparison circuit 340.

The vertical synchronization timing comparison circuit 330 compares the data received by the receiving circuit 300 (i.e., parallel data converted by the S/P conversion circuit 304) with the given vertical synchronization timing designation data. When the data received by the receiving circuit 300 coincides with the vertical synchronization timing designation data, the vertical synchronization timing comparison circuit 330 outputs a pulse of a vertical synchronization signal VSYNC. The pulse of the vertical synchronization signal VSYNC specifies one vertical scan period. As shown in FIG. 3, the vertical synchronization timing designation data is the B₁-bit data in the super-white area (super-black area) designated in advance by the vertical synchronization timing data generation circuit 240 of the display controller 38. The source driver 30 further includes a vertical synchronization designation data setting register 332. The vertical synchronization timing designation data is set in the vertical synchronization designation data setting register 332 by a register access from the host or the display controller 38.

The horizontal synchronization timing comparison circuit 340 compares the data received by the receiving circuit 300 (i.e., parallel data converted by the S/P conversion circuit 304) with the given horizontal synchronization timing designation data. When the data received by the receiving circuit 300 coincides with the horizontal synchronization timing designation data, the horizontal synchronization timing comparison circuit 340 outputs a pulse of a horizontal synchronization signal HSYNC. The pulse of the horizontal synchronization signal HSYNC specifies one horizontal scan period. As shown in FIG. 3, the horizontal synchronization timing designation data is the B₁-bit data in the super-white area (super-black area) designated in advance by the horizontal synchronization timing data generation circuit 250 of the display controller 38. The source driver 30 further includes a horizontal synchronization designation data setting register 342. The horizontal synchronization timing designation data is set in the horizontal synchronization designation data setting register 342 by a register access from the host or the display controller 38.

It is desirable that the vertical synchronization timing comparison circuit 330 designate the vertical synchronization timing using the data received by the receiving circuit 300 on condition that the data received by the receiving circuit 300 has successively coincided with the vertical synchronization timing designation data a given number of times (e.g., ten times). This significantly reduces a situation in which the vertical synchronization timing is erroneously designated when the received data has changed due to noise superimposed on the differential signal lines.

It is desirable that the horizontal synchronization timing comparison circuit 340 designate the horizontal synchronization timing using the data received by the receiving circuit 300 on condition that the data received by the receiving circuit 300 has successively coincided with the horizontal synchronization timing designation data a given number of times (e.g., ten times). This significantly reduces a situation in which the horizontal synchronization timing is erroneously designated when the received data has changed due to noise superimposed on the differential signal lines.

When the vertical synchronization timing or the horizontal synchronization timing is designated on condition that the received data has successively coincided with the vertical synchronization timing designation data or the horizontal synchronization timing designation data a given number of times, the vertical synchronization timing designation data or the horizontal synchronization timing designation data may be changed at least once. For example, when the vertical synchronization timing designation data is “11 . . . 111” and the given number of times is ten, the vertical synchronization timing designation data may be changed to “11 . . . 110” only once. This further reduces a situation in which the vertical synchronization timing or the horizontal synchronization timing is erroneously designated when using the comparison result of the vertical synchronization timing comparison circuit 330 or the horizontal synchronization timing comparison circuit 340.

The source driver 30 can reduce power consumption by masking the comparison result of the vertical synchronization timing comparison circuit 330 as described below.

Specifically, the source driver 30 may include a first counter 350. The first counter 350 starts a count operation after the vertical synchronization timing comparison circuit 330 has detected that the data received by the receiving circuit 300 coincides with the vertical synchronization timing designation data. The first counter 350 masks the comparison result between the received data and the vertical synchronization timing designation data until the count value of the first counter 350 reaches a first count value equal to or less than a data reception count value corresponding to the number of scan lines.

FIG. 6 is a timing diagram showing an operation example of the vertical synchronization timing comparison circuit 330.

When the vertical synchronization timing comparison circuit 330 has detected that the data received by the receiving circuit 300 coincides with the vertical synchronization timing designation data set in the vertical synchronization designation data setting register 332, the vertical synchronization timing comparison circuit 330 outputs a pulse of the vertical synchronization signal VSYNC. The first counter 350 starts a count operation based on the rising edge of the vertical synchronization signal VSYNC, and increments the count value corresponding to each horizontal scan period specified by the horizontal synchronization signal HSYNC, for example.

The first counter 350 compares the count value with the given first count value, and masks the comparison result of the vertical synchronization timing comparison circuit 330 until the count value coincides with the first count value. It is desirable that the first count value be a value equal to or less than the reception count value of the first counter 350 when the grayscale data corresponding to the number of scan lines of the LCD panel 20 has been received.

Therefore, since the receiving circuit 300 receives the grayscale data of the image displayed on the LCD panel 20 until the count value of the first counter 350 reaches the reception count value corresponding to the number of scan lines of the LCD panels 20 based on the rising edge of the vertical synchronization signal VSYNC, the receiving circuit 300 does not receive the data corresponding to the vertical synchronization signal until the count value of the first counter 350 reaches the reception count value. The comparison process need not be unnecessarily performed by causing the first counter 350 to start the comparison process at least immediately before the reception count value is reached. Moreover, a situation in which the vertical synchronization timing is erroneously detected due to noise superimposed on the differential signal lines can be prevented.

Therefore, the comparison result of the vertical synchronization timing comparison circuit 330 is masked (mask period) until the count value of the first counter 350 reaches the first count value based on the rising edge of the vertical synchronization signal VSYNC, and the comparison result of the vertical synchronization timing comparison circuit 330 is not masked (non-mask period) after the mask period until the rising edge of the vertical synchronization signal VSYNC in the subsequent vertical scan period occurs.

The source driver 30 can reduce power consumption by masking the comparison result of the horizontal synchronization timing comparison circuit 340 as described below.

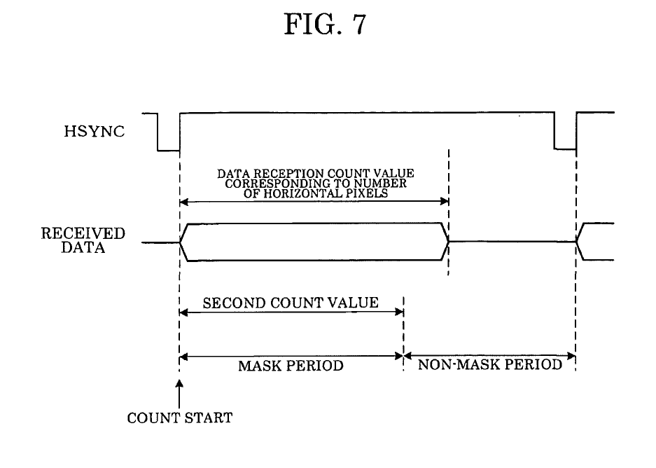

FIG. 7 is a timing diagram showing an operation example of the horizontal synchronization timing comparison circuit 340.

When the horizontal synchronization timing comparison circuit 340 has detected that the data received by the receiving circuit 300 coincides with the horizontal synchronization timing designation data set in the horizontal synchronization designation data setting register 342, the horizontal synchronization timing comparison circuit 340 outputs a pulse of the horizontal synchronization signal HSYNC. A second counter 360 starts a count operation based on the rising edge of the horizontal synchronization signal HSYNC, and increments the count value corresponding to each pulse of the dot clock signal, for example.

The second counter 360 compares the count value with a given second count value, and masks the comparison result of the horizontal synchronization timing comparison circuit 340 until the count value coincides with the second count value. It is desirable that the second count value be a value equal to or less than the reception count value of the second counter 360 when the grayscale data corresponding to the number of horizontal pixels of the LCD panel 20 has been received.

Therefore, since the receiving circuit 300 receives the grayscale data of the image displayed on the LCD panel 20 until the count value of the second counter 360 reaches the reception count value corresponding to the number of horizontal pixels of the LCD panels 20 based on the rising edge of the horizontal synchronization signal HSYNC, the receiving circuit 300 does not receive the data corresponding to the horizontal synchronization signal until the count value of the second counter 360 reaches the reception count value. The comparison process need not be unnecessarily performed by causing the second counter 360 to start the comparison process at least immediately before the reception count value is reached. Moreover, a situation in which the horizontal synchronization timing is erroneously detected due to noise superimposed on the differential signal lines can be prevented.

Therefore, the comparison result of the horizontal synchronization timing comparison circuit 340 is masked (mask period) until the count value of the second counter 360 reaches the second count value based on the rising edge of the horizontal synchronization signal HSYNC, and the comparison result of the horizontal synchronization timing comparison circuit 340 is not masked (non-mask period) after the mask period until the rising edge of the horizontal synchronization signal HSYNC in the subsequent horizontal scan period occurs.

The data format of the differential data according to this embodiment transmitted through the differential signal lines is described below.

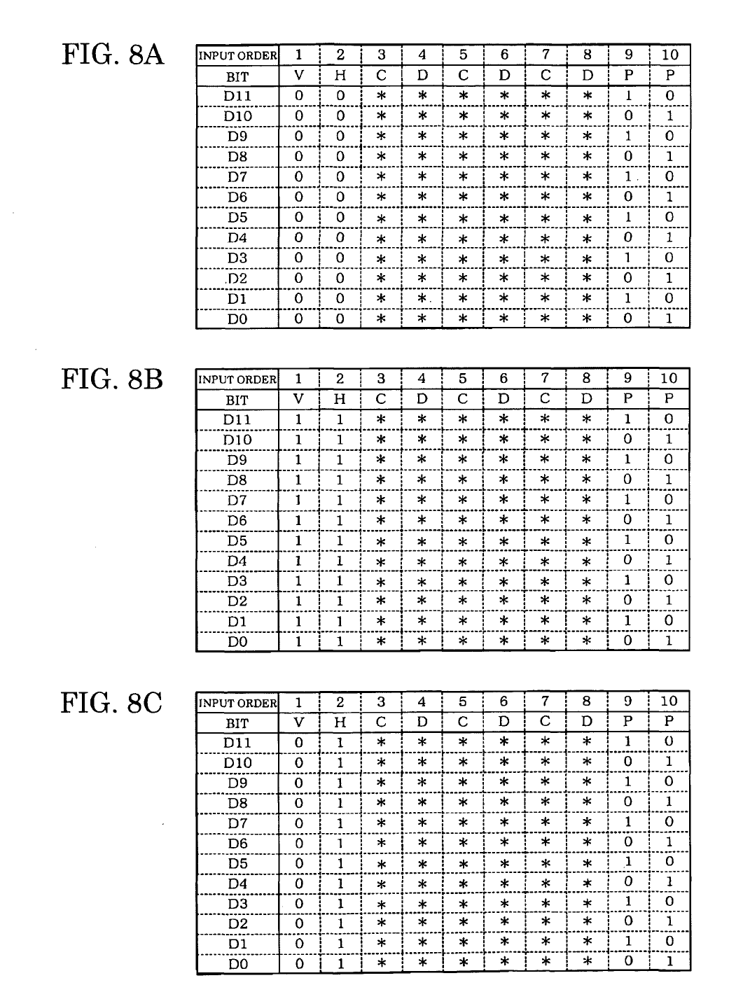

FIGS. 8A, 8B, and 8C are views illustrative of the data format of the differential data according to this embodiment transmitted through the differential signal lines.

FIG. 8A shows an example of the format of VSYNC designation data. FIG. 8B shows an example of the format of HSYNC designation data. FIG. 8C shows an example of the format of VSYNC/HSYNC designation data.

The designation data is transmitted to the source driver 30 by ten transmissions in units of 12 bits. A V field, an H field, a C field, a D field, and a P field are defined in the format of the designation data. The vertical synchronization timing designation data is set in the V field. The horizontal synchronization timing designation data is set in the H field. Command data for controlling the source driver 30 is set in the C field. Data is input to the D field. Parity data for a parity check is input to the P field twice in a bit-inverted manner.

The D field may be referred to as an image data field that designates the image data of the LCD panel 20. The V field, the H field, the C field, and the P field may be referred to as flag fields that designate the vertical synchronization timing, the horizontal synchronization timing, and the parity data. Therefore, the flag fields include an area that designates the command for controlling the source driver 30.

The vertical synchronization timing comparison circuit 330 detects whether or not the 12-bit data in the V field is the vertical synchronization timing designation data on condition that no error has been detected based on the parity data in the P field in the data format shown in FIGS. 8A to 8C.

The horizontal synchronization timing comparison circuit 340 detects whether or not the 12-bit data in the H field is the horizontal synchronization timing designation data on condition that no error has been detected based on the parity data in the P field in the data format shown in FIGS. 8A to 8C.

The source driver 30 thus determines whether the differential data is the VSYNC designation data, the HSYNC designation data, or the VSYNC/HSYNC designation data shown in FIGS. 8A to 8C. For example, when the source driver 30 has determined that the differential data is the HSYNC designation data, the source driver 30 handles the differential data as the grayscale data of the image displayed on the LCD panel 20 immediately after the parity data contained in the HSYNC designation data. For example, when the source driver 30 has determined that the differential data is the VSYNC designation data, the source driver 30 handles the differential data as the grayscale data of the image displayed on the LCD panel 20 immediately after the parity data contained in the VSYNC designation data.

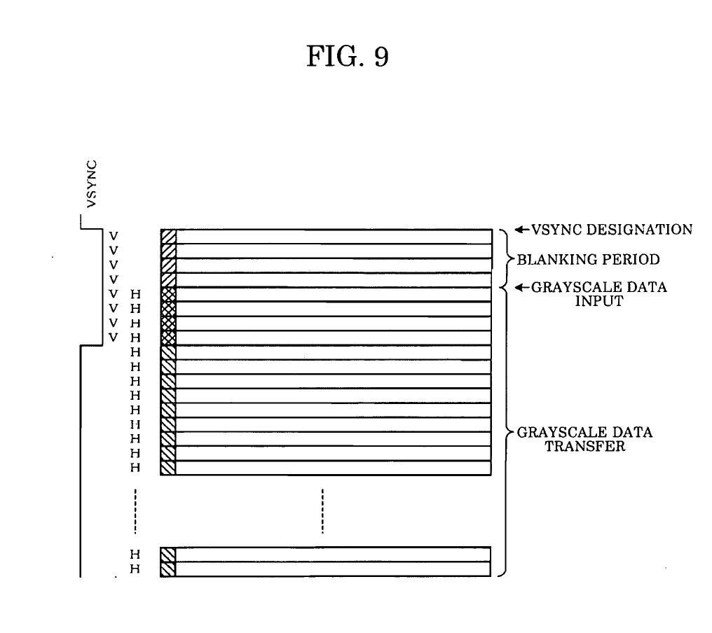

FIG. 9 shows an input example of the differential data shown in FIGS. 8A to 8C.

For example, the VSYNC designation data shown in FIG. 8A is input, and the differential data handled as a dummy is then input. In a blanking period, the VSYNC designation data is input, and the differential data handled as a dummy is then input.

The VSYNC/HSYNC designation data shown in FIG. 8B is then input, followed by the differential data handled as a dummy. Likewise, the VSYNC/HSYNC designation data is then input, followed by the differential data handled as a dummy.

The HSYNC designation data shown in FIG. 8C is then input, followed by the differential data handled as a dummy. Likewise, the HSYNC designation data is then input, followed by the differential data handled as a dummy.

3. Specific Configuration Example

A liquid crystal device, an electro-optical device, and an electronic instrument to which the source driver according to this embodiment is applied are described below.

3.1 Liquid Crystal Device

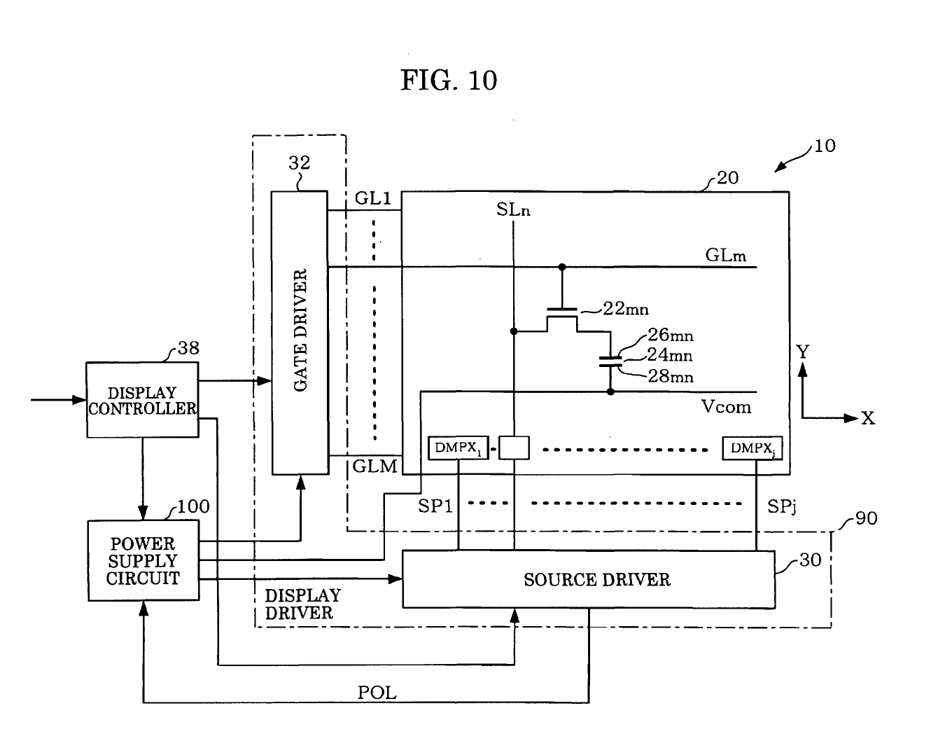

FIG. 10 schematically shows the configuration of an active matrix type liquid crystal device according to this embodiment. Although the following description is given taking an example of an active matrix type liquid crystal device, the source driver according to this embodiment may also be applied to other liquid crystal devices.

The following description illustrates an example in which a liquid crystal display panel of the liquid crystal device is driven by multiplex drive. Note that the invention may also be applied to the case where the liquid crystal display panel is driven normally (i.e., non-multiplex drive). The term “multiplex drive” refers to a drive method in which drive signals corresponding to a plurality of source lines are time-division multiplexed corresponding to each output. The term “non-multiplex drive” refers to a drive method in which a drive signal corresponding to each source line is output corresponding to each output.

The liquid crystal device 10 includes the LCD panel (display panel in a broad sense; electro-optical device in a broader sense) 20. The LCD panel 20 is a high-temperature polysilicon liquid crystal panel. The LCD panel 20 is formed on a glass substrate, for example. A plurality of gate lines (scan lines) GL1 to GLM (M is an integer equal to or larger than two), arranged in a direction Y and extending in a direction X, and a plurality of source lines (data lines) SL1 to SLN (N is an integer equal to or larger than two), arranged in the direction X and extending in the direction Y, are disposed on the glass substrate. The LCD panel 20 includes demultiplexers DMPX₁ to DMPXⱼ (j is an integer equal to or larger than two) provided corresponding to the source lines. The LCD panel 20 separates a source output from a source driver, and outputs a drive voltage to each of the source lines SL1 to SLN.

A pixel area (pixel) is provided corresponding to the intersection of the gate line GLm (1≦m≦M, m is an integer; hereinafter the same) and the source line SLn (1≦n≦N, n is an integer; hereinafter the same). A thin film transistor (hereinafter abbreviated as “TFT”) 22mn is disposed in the pixel area.

The gate of the TFT 22mn is connected to the gate line GLm. The source of the TFT 22mn is connected to the source line SLn. The drain of the TFT 22mn is connected to a pixel electrode 26mn. A liquid crystal (electro-optical element in a broad sense) is sealed between the pixel electrode 26mn and a common electrode 28mn opposite to the pixel electrode 26mn so that a liquid crystal capacitor (liquid crystal element in a broad sense) 24mn is formed. The transmissivity of the pixel changes corresponding to the voltage applied between the pixel electrode 26mn and the common electrode 28mn. A common electrode voltage Vcom is supplied to the common electrode 28mn.

The LCD panel 20 is formed by bonding a first substrate provided with the pixel electrode and the TFT and a second substrate provided with the common electrode, and sealing a liquid crystal (electro-optical material) between the first and second substrates, for example.

Specifically, the LCD panel 20 includes a pixel electrode connected to a source line through a TFT as a switch element. In other words, the LCD panel 20 includes a plurality of source lines, a plurality of switch elements, and a plurality of pixel electrodes, each of the pixel electrodes being connected to a source line among the plurality of source lines through a switch element among the plurality of switch elements.

The liquid crystal device 10 includes a display driver (driver circuit in a broad sense) 90 that drives the LCD panel 20. The display driver 90 includes the source driver 30. The source driver 30 multiplex-drives the source lines SL1 to SLN of the LCD panel 20 based on image data (grayscale data) corresponding to each source line. Specifically, the source driver 30 time-division multiplexes drive voltages output to a plurality of source lines, and outputs the multiplexed drive voltages to source voltage supply lines SP₁ to SPⱼ. The demultiplexer of the LCD panel 20 connected to the corresponding source voltage supply line separates the multiplexed drive voltages supplied from the source voltage supply line at a separation timing designated by the source driver 30, and supplies the separated drive voltages to a plurality of source lines. In FIG. 10, the demultiplexers are included in the LCD panel 20. Note that the source driver 30 may include the demultiplexers DMPX₁ to DMPXⱼ.

The display driver 90 may include a gate driver (scan driver in a broad sense) 32. The gate driver 32 scans the gate lines GL1 to GLM of the LCD panel 20 within one vertical scan period. The display driver 90 may have a configuration in which at least one of the source driver 30 and the gate driver 32 is omitted.

The liquid crystal device 10 may include a power supply circuit 100. The power supply circuit 100 generates voltages necessary for driving the source lines, and supplies the generated voltages to the source driver 30. For example, the power supply circuit 100 generates power supply voltages VDDH and VSSH necessary for the source driver 30 to drive the source lines, and voltages necessary for a logic section of the source driver 30.

The power supply circuit 100 also generates voltages necessary for scanning the gate lines, and supplies the generated voltages to the gate driver 32.

The power supply circuit 100 also generates the common electrode voltage Vcom. The power supply circuit 100 outputs the common electrode voltage Vcom to the common electrode of the LCD panel 20. The common electrode voltage Vcom is periodically set at a high-potential-side voltage VCOMH and a low-potential-side voltage VCOML in synchronization with the timing of a polarity inversion signal POL generated by the source driver 30.

The liquid crystal device 10 may include the display controller 38. The display controller 38 controls the source driver 30, the gate driver 32, and the power supply circuit 100 according to information set by a host (not shown) such as a central processing unit (hereinafter abbreviated as “CPU”). For example, the display controller 38 sets the operation mode of the source driver 30 and the gate driver 32, and supplies a vertical synchronization signal and a horizontal synchronization signal generated therein to the source driver 30 and the gate driver 32. The display controller 38 and the source driver 30 are connected through differential signal lines. Hence, the display controller 38 sets the operation mode of the source driver 30 and the gate driver 32, and supplies a vertical synchronization signal and a horizontal synchronization signal generated therein to the source driver 30 and the gate driver 32 through the differential signal lines.

In FIG. 10, the liquid crystal device 10 includes the power supply circuit 100 and the display controller 38. Note that at least one of the power supply circuit 100 and the display controller 38 may be provided outside the liquid crystal device 10. Or, the liquid crystal device 10 may include the host.

The source driver 30 may include at least one of the gate driver 32 and the power supply circuit 100.

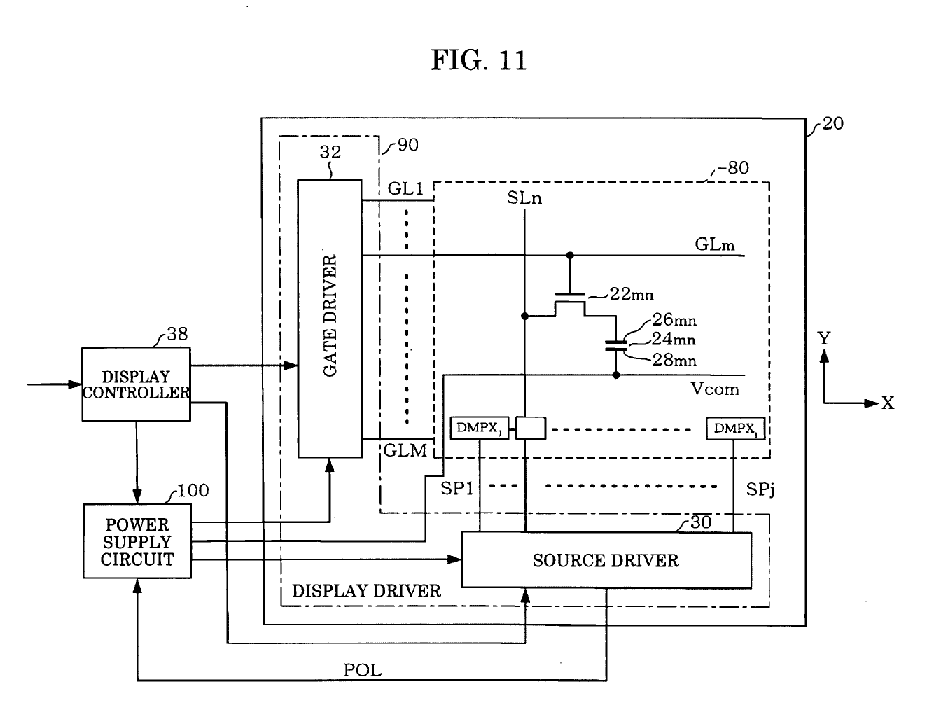

Some or all of the source driver 30, the gate driver 32, the display controller 38, and the power supply circuit 100 may be formed on the LCD panel 20. In FIG. 11, the display driver 90 (source driver 30 and gate driver 32) is formed on the LCD panel 20, for example. Specifically, the LCD panel 20 may be configured to include a plurality of source lines, a plurality of gate lines, a plurality of switch elements, each of the plurality of switch elements being connected to a gate line among the plurality of gate lines and a source line among the plurality of source lines, and a source driver that drives the plurality of source lines. A plurality of pixels are formed in a pixel formation area 80 of the LCD panel 20.

3.2 Gate Driver

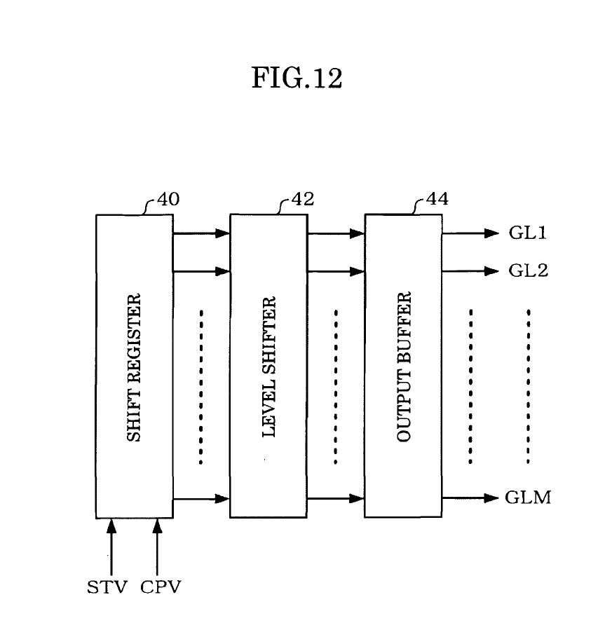

FIG. 12 shows a configuration example of the gate driver 32 shown in FIG. 10 or 11.

The gate driver 32 includes a shift register 40, a level shifter 42, and an output buffer 44.

The shift register 40 includes a plurality of flip-flops provided corresponding to the gate lines and connected sequentially. The shift register 40 holds a start pulse signal STV in the flip-flop in synchronization with a clock signal CPV, and sequentially shifts the start pulse signal STV to the adjacent flip-flops in synchronization with the clock signal CPV. The clock signal CPV is a horizontal synchronization signal (HSYNC), and the start pulse signal STV is a vertical synchronization signal (VSYNC).

The level shifter 42 shifts the level of the voltage input from the shift register 40 to a voltage level corresponding to the liquid crystal element of the LCD panel 20 and the transistor performance of the TFT.

The output buffer 44 buffers a scan voltage shifted by the level shifter 42, and outputs the scan voltage to the gate line to drive the gate line. The high-potential-side voltage of the pulsed scan voltage is a select voltage, and the low-potential-side voltage of the pulsed scan voltage is a non-select voltage.

The gate driver 32 may scan the gate lines by selecting the gate line corresponding to the decoding result of an address decoder instead of scanning the gate lines using the shift register, differing from FIG. 12.

3.3 Source Driver

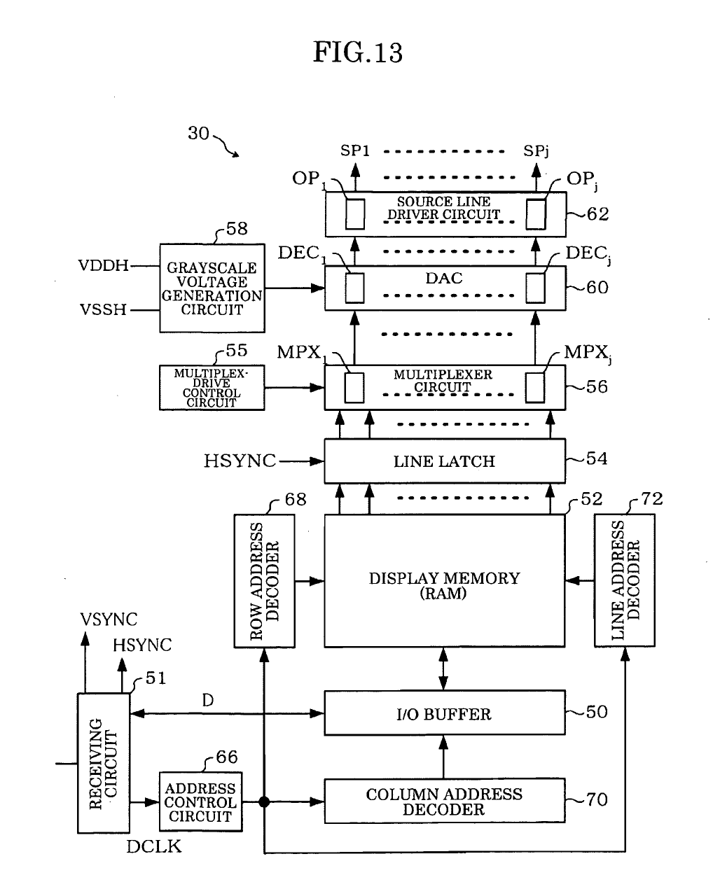

FIG. 13 shows a detailed configuration example of the source driver 30 shown in FIG. 10 or 11.

The source driver 30 includes a receiving circuit 51, an I/O buffer 50, a display memory 52, a line latch 54, a multiplex-drive control circuit 55, a multiplexer circuit 56, a grayscale voltage generation circuit 58, a digital/analog converter (DAC) 60, and a source line driver circuit 62.

Grayscale data D (image data) is input to the source driver 30 from the display controller 38 through the differential signal lines.

The receiving circuit 51 has the functions of the receiving circuit 300, the vertical synchronization timing comparison circuit 330, the vertical synchronization designation data setting register 332, the horizontal synchronization timing comparison circuit 340, the horizontal synchronization designation data setting register 342, and the first and second counters 350 and 360 shown in FIG. 4. The grayscale data D received by the receiving circuit 51 is buffered by the I/O buffer 50. A dot clock signal DCLK is supplied from the display controller 38.

The display controller 38 or the host (not shown) accesses the I/O buffer 50. The grayscale data buffered by the I/O buffer 50 is written into the display memory 52. The grayscale data read from the display memory 52 is buffered by the I/O buffer 50, and is output to the display controller 38 and the like.

The display memory 52 includes a plurality of memory cells provided corresponding to output lines connected to the source lines. Each memory cell is specified by a row address and a column address. The memory cells corresponding to one scan line are specified by a line address.

An address control circuit 66 generates a row address, a column address, and a line address that specify the memory cell of the display memory 52. The address control circuit 66 generates a row address and a column address when writing the grayscale data into the display memory 52. Specifically, the grayscale data buffered by the I/O buffer 50 is written into the memory cell of the display memory 52 specified by the row address and the column address.

A row address decoder 68 decodes the row address, and selects the memory cells of the display memory 52 corresponding to the row address. A column address decoder 70 decodes the column address, and selects the memory cells of the display memory 52 corresponding to the column address.

The address control circuit 66 generates the line address when reading the grayscale data from the display memory 52 and outputting the grayscale data to the line latch 54. Specifically, a line address decoder 72 decodes the line address, and selects the memory cells of the display memory 52 corresponding to the line address. The grayscale data corresponding to one horizontal scan read from the memory cells specified by the line address is output to the line latch 54.

The address control circuit 66 generates the row address and the column address when reading the grayscale data from the display memory 52 and outputting the grayscale data to the I/O buffer 50. Specifically, the grayscale data stored in the memory cell of the display memory 52 specified by the row address and the column address is written into the I/O buffer 50. The grayscale data written into the I/O buffer 50 is acquired by the display controller 38 or the host (not shown).

Therefore, the row address decoder 68, the column address decoder 70, and the address control circuit 66 shown in FIG. 13 function as a write control circuit that controls writing of the grayscale data into the display memory 52. The line address decoder 72, the column address decoder 70, and the address control circuit 66 shown in FIG. 13 function as a read control circuit that controls reading of the grayscale data from the display memory 52.

The line latch 54 latches the grayscale data corresponding to one horizontal scan read from the display memory 52 at a change timing of the horizontal synchronization signal HSYNC (latch pulse LP) that specifies one horizontal scan period. The line latch 54 includes a plurality of registers, each of the plurality of registers storing the grayscale data corresponding to one dot. The grayscale data corresponding to one dot read from the display memory 52 is stored in each of the plurality of registers of the line latch 54.

The multiplex-drive control circuit 55 generates a multiplex control signal for time-division multiplexing the grayscale data corresponding to each source line.

The multiplexer circuit 56 includes multiplexers MPX₁ to MPXⱼ. Each multiplexer generates multiplexed data by time-division multiplexing the grayscale data corresponding to one horizontal scan latched by the line latch 54 based on the multiplex control signal in units of k (k is a positive integer; k×j=N) source outputs.

The grayscale voltage generation circuit 58 generates a plurality of grayscale voltages (reference voltages) corresponding to the grayscale data. Specifically, the grayscale voltage generation circuit 58 generates the grayscale voltages corresponding to the grayscale data based on the high-potential-side power supply voltage VDDH and the low-potential-side power supply voltage VSSH.

The DAC 60 generates the grayscale voltage corresponding to the grayscale data multiplexed into the multiplexed data from each multiplexer of the multiplexer circuit 56 corresponding to each source output. Specifically, the DAC 60 selects the grayscale voltage corresponding to each piece of grayscale data multiplexed into the multiplexed data from each multiplexer of the multiplexer circuit 56 from the grayscale voltages generated by the grayscale voltage generation circuit 58, and outputs the selected grayscale voltage as a multiplexed grayscale voltage. The DAC 60 includes voltage select circuits DEC₁ to DECⱼ provided corresponding to the source outputs. Each voltage select circuit outputs one grayscale voltage corresponding to the grayscale data of the multiplexed data from the grayscale voltages from the grayscale voltage generation circuit 58.

The source line driver circuit 62 includes output circuits OP₁ to OPⱼ. Each of the output circuits OP₁ to OPⱼ includes a voltage-follower-connected operational amplifier. Each output circuit performs impedance conversion using the multiplexed grayscale voltage from each voltage select circuit of the DAC 60, and drives its output.

The source line driver circuit 310 shown in FIG. 4 may have the functions of the multiplex-drive control circuit 55, the multiplexer circuit 56, the grayscale voltage generation circuit 58, and the DAC 60 in addition to the source line driver circuit 62 shown in FIG. 13.

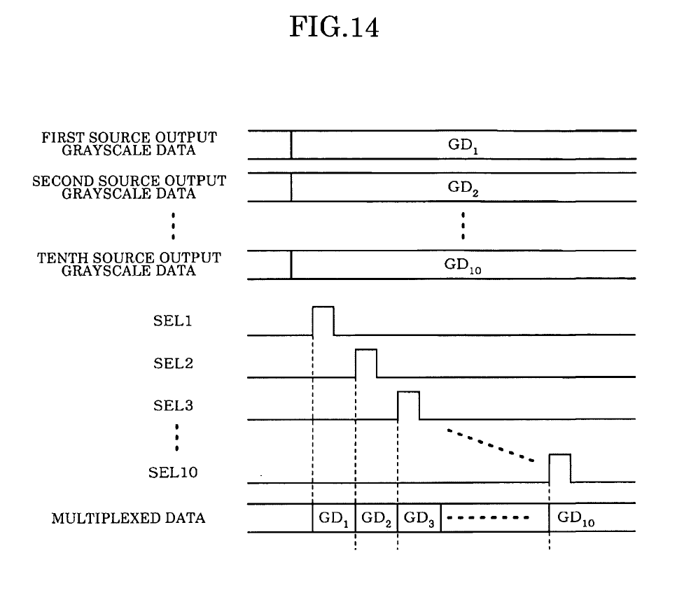

FIG. 14 shows an operation example of the multiplexer MPX₁ shown in FIG. 13.

The multiplexer MPX₁ generates multiplexed data by time-division multiplexing the grayscale data corresponding to ten source lines. First to tenth source output grayscale data GD₁ to GD₁₀ latched by the line latch 54 is multiplexed by the multiplexer MPX₁ of the multiplexer circuit 56. Multiplex control signals SEL1 to SEL10 that specify the time division timing are input to each of the multiplexers MPX₁ to MPXⱼ. The multiplex control signals SEL1 to SEL10 are generated by the multiplex-drive control circuit 55 of the source driver 30. The multiplex-drive control circuit 55 generates the multiplex control signals SEL1 to SEL10 so that one of the multiplex control signals SEL1 to SEL10 is sequentially set at the H level within one horizontal scan period, for example. The grayscale data corresponding to the multiplex control signal is output as the multiplexed data in a period in which the multiplex control signal is set at the H level.

The multiplexer circuit 56 may time-division multiplex the grayscale data corresponding to a plurality of pixels respectively including a plurality of dots, or may time-division multiplex the grayscale data corresponding to a plurality of dots of the same color component that form each pixel.

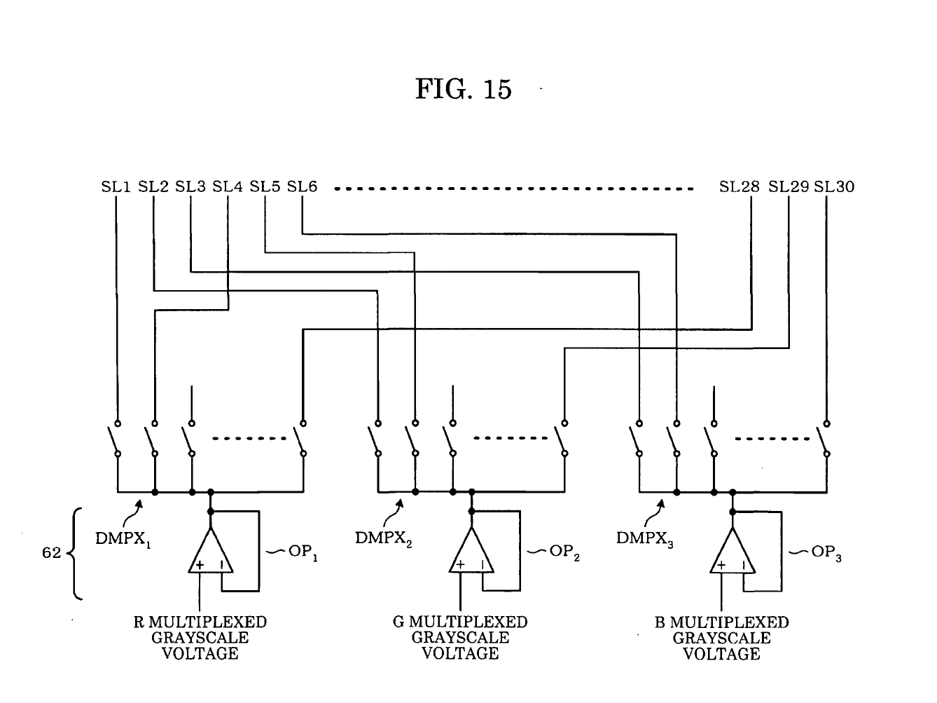

FIG. 15 is a circuit diagram showing a configuration example of the demultiplexer of the LCD panel 20.

In FIG. 15, the output circuits provided corresponding to RGB color components perform 10-multiplex drive. In this case, each demultiplexer performs an operation which is the reverse of that of the multiplexer of the multiplexer circuit 56 corresponding to the demultiplexer. Specifically, each demultiplexer separates the multiplexed grayscale voltage from the corresponding output circuit of the source line driver circuit 62, and outputs the separated grayscale voltages to ten source outputs. The separation timing of the demultiplexer is synchronized with the time division timing of each multiplexer of the multiplexer circuit 56.

FIG. 15 shows an example of the demultiplexers DMPX₁ to DMPX₃ that separate the multiplexed grayscale voltage corresponding to the source lines SL1 to SL30. Each demultiplexer separates the grayscale voltage corresponding to each color component of one pixel. Specifically, each output circuit OP₁ of the source driver 30 drives the source voltage supply line so that 10-multiplex drive is performed corresponding to each color component. This prevents a phenomenon in which a separation line occurs due to a variation in the output circuit OP₁ even when the same grayscale voltage is output, whereby the image quality can be improved.

An R multiplexed grayscale voltage (for the R component among the RGB components) is input to the output circuit OP₁ from the voltage select circuit DEC₁ of the DAC 60. The output circuit OP₁ performs impedance conversion using the R multiplexed grayscale voltage, and drives its output. Demultiplex control signals synchronized with the time division timing of the multiplexer circuit 56 are input to the demultiplexer DMPX₁. The demultiplexer DMPX₁ sequentially outputs the output voltage from the output circuit OP₁ to the source lines SL1, SL4, SL7, SL10, . . . , and SL28 only in a period specified by demultiplex control signals.

A G multiplexed grayscale voltage (for the G component among the RGB components) is input to the output circuit OP₂ from the voltage select circuit DEC₂ of the DAC 60. The output circuit OP₂ performs impedance conversion using the G multiplexed grayscale voltage, and drives its output. The demultiplex control signals synchronized with the time division timing of the multiplexer circuit 56 are input to the demultiplexer DMPX₂. The demultiplexer DMPX₂ sequentially outputs the output voltage from the output circuit OP₂ to the source lines SL2, SL5, SL8, SL11, . . . , and SL29 only in a period specified by demultiplex control signals.

A B multiplexed grayscale voltage (for the B component among the RGB components) is input to the output circuit OP₃ from the voltage select circuit DEC₃ of the DAC 60. The output circuit OP₃ performs impedance conversion using the B multiplexed grayscale voltage, and drives its output. The demultiplex control signals synchronized with the time division timing of the multiplexer circuit 56 are input to the demultiplexer DMPX₃. The demultiplexer DMPX₃ sequentially outputs the output voltage from the output circuit OP₃ to the source lines SL3, SL6, SL9, SL12, . . . , and SL30 only in a period specified by demultiplex control signals.

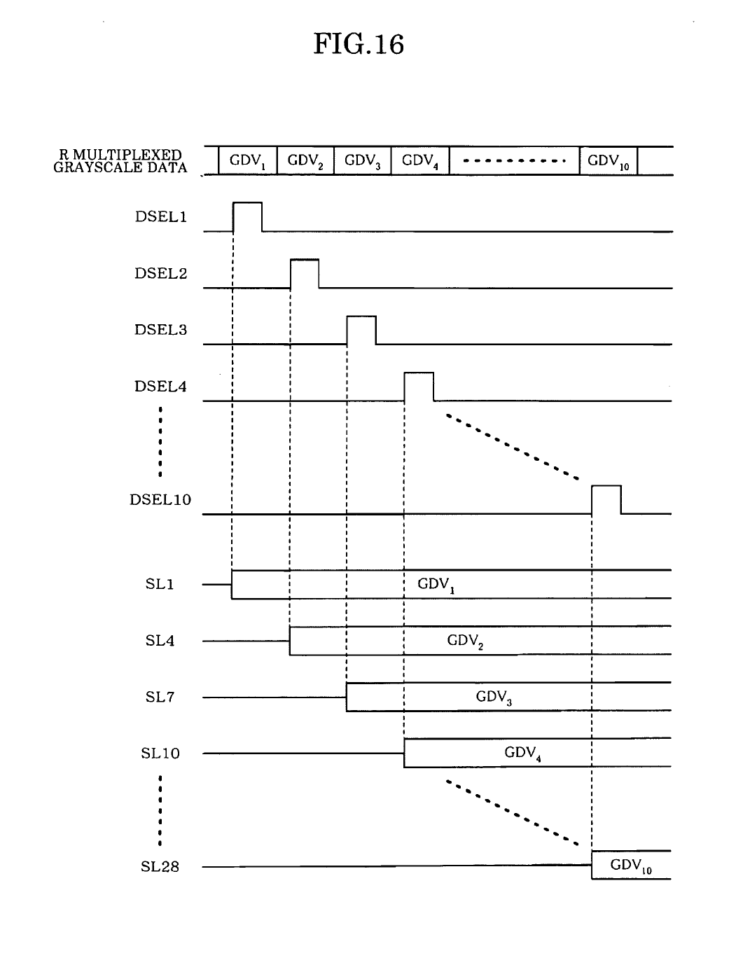

FIG. 16 is a view illustrative of the operation of the demultiplexer shown in FIG. 15.

FIG. 16 illustrates the operation of the demultiplexer DMPX₁ shown in FIG. 15. Note that other demultiplexers operate in the same manner as the demultiplexer DMPX₁.

The demultiplexer DMUX₁ separates the grayscale voltages GDV₁, GDV₂, GDV₃, . . . , and GDV₁₀ that are time-division multiplexed as the R multiplexed grayscale voltage, and outputs the separated grayscale voltages to the source lines. The grayscale voltage GDV₁ is the grayscale voltage corresponding to the grayscale data GD₁ among a plurality of grayscale voltages generated by the grayscale voltage generation circuit 58. The grayscale voltage GDV₂ is the grayscale voltage corresponding to the grayscale data GD₂ among a plurality of grayscale voltages generated by the grayscale voltage generation circuit 58. Likewise, the grayscale voltage GDV₁₀ is the grayscale voltage corresponding to the grayscale data GD₁₀ among a plurality of grayscale voltages generated by the grayscale voltage generation circuit 58.

Demultiplex control signals DSEL1 to SEL10 are input to the demultiplexers DMPX₁ to DMPX₃. The demultiplex control signals DSEL1 to DSEL10 are signals synchronized with the multiplex control signals SEL1 to SEL10, respectively. The demultiplex control signals DSEL1 to DSEL10 are generated by the multiplex-drive control circuit 55 of the source driver 30. The multiplex-drive control circuit 55 generates the demultiplex control signals DSEL1 to DSEL10 so that one of the demultiplex control signals DSEL1 to DSEL10 is sequentially set at the H level within one horizontal scan period, for example. The grayscale voltage in a period in which the demultiplex control signal is set at the H level among the grayscale voltages multiplexed into the R multiplexed grayscale data is output to the source line corresponding to the demultiplex control signal.

Therefore, the demultiplexer DMPX₁ can output the grayscale voltages GDV₁, GDV₂, GDV₃, . . . , and GDV₁₀ separated from the R multiplexed grayscale voltage (see FIG. 16) to the source lines SL1, SL4, SL7, . . . , and SL28. The demultiplexers DMPX₂ and DMPX₃ can also output the grayscale voltages separated from the G multiplexed grayscale voltage and the B multiplexed grayscale voltage to the source lines in the same manner as the demultiplexer DMPX₁.

3.3.1 Modification

In the above-described embodiments, the source driver multiplex-drives the LCD panel 20 (high-temperature polysilicon liquid crystal panel) on which the demultiplexers DMPX₁ to DMPXⱼ are formed. Note that the invention is not limited thereto.

A source driver according to a modification drives an LCD panel (amorphous silicon liquid crystal panel) in which the demultiplexers DMPX₁ to DMPXⱼ are not formed on a panel substrate. In this case, the source driver has the function of the demultiplexers DMPX₁ to DMPXⱼ in the above-described embodiments.

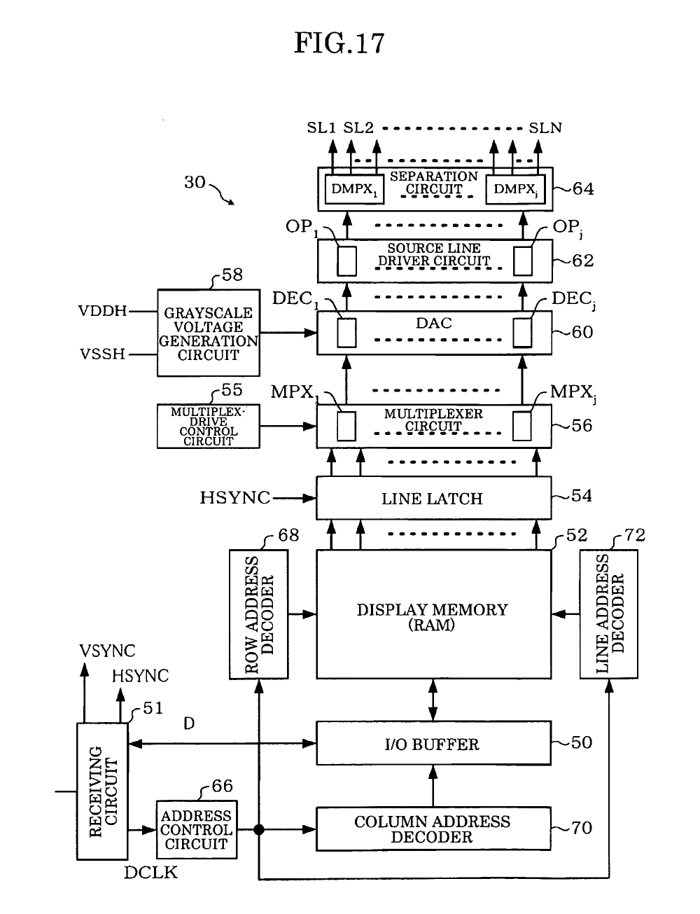

FIG. 17 is a block diagram showing a configuration example of a source driver according to this modification.

In FIG. 17, the same sections as in FIG. 13 are indicated by the same symbols. Description of these sections is appropriately omitted. The source driver shown in FIG. 17 differs from the source driver shown in FIG. 13 in that a separation circuit 64 is provided on the output side of the source line driver circuit 62. The separation circuit 64 includes the demultiplexers DMPX₁ to DMPXⱼ provided on the LCD panel 20 in FIG. 10 or 11. The function of the separation circuit 64 is the same as described with reference to FIG. 16. Therefore, detailed description is omitted.

4. Electronic Instrument

An electronic instrument to which the liquid crystal device 10 (source driver 30) according to the above-described embodiments is applied is described below.

4.1 Projection-Type Display Device

An electronic instrument formed using the liquid crystal device 10 may be a projection-type display device.

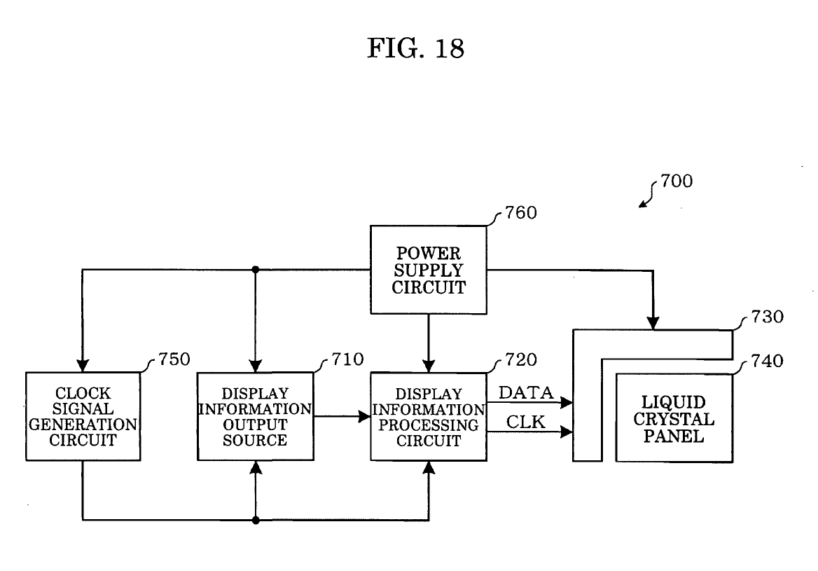

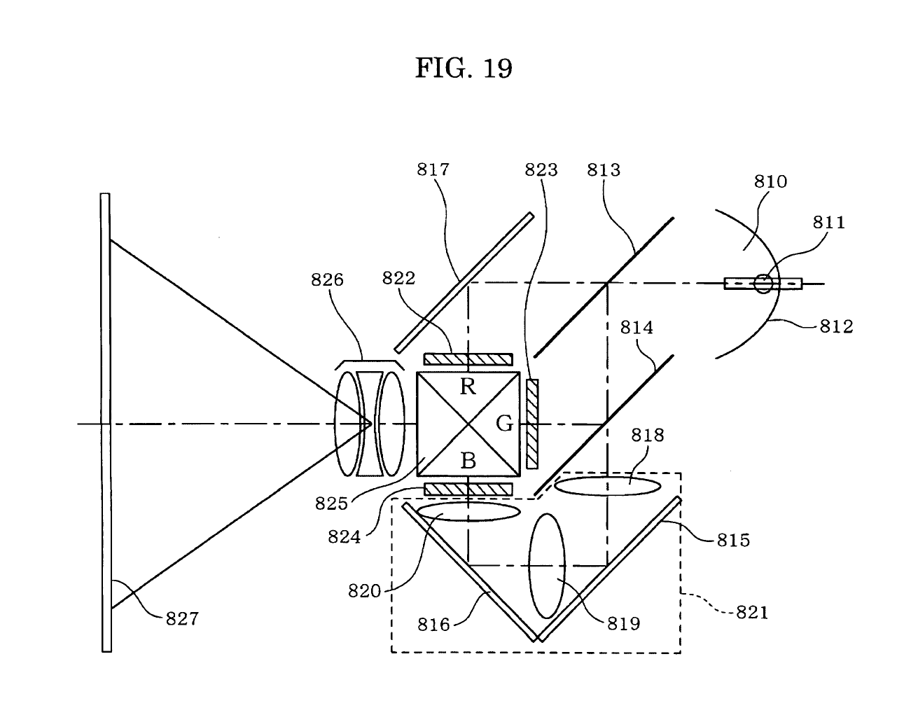

FIG. 18 is a block diagram showing a configuration example of a projection-type display device to which the liquid crystal device 10 according to the above-described embodiments is applied.

A projection-type display device 700 includes a display information output source 710, a display information processing circuit 720, a display driver circuit 730 (display driver), a liquid crystal panel 740, a clock signal generation circuit 750, and a power supply circuit 760. The display information output source 710 includes a memory such as a read only memory (ROM), a random access memory (RAM), or an optical disk device, and a tuning circuit which tunes and outputs an image signal. The display information output source 710 outputs display information (e.g., image signal in a given format) to the display information processing circuit 720 based on a clock signal from the clock signal generation circuit 750. The display information processing circuit 720 may include an amplification/polarity inversion circuit, a phase expansion circuit, a rotation circuit, a gamma correction circuit, a clamping circuit, and the like. The display driver circuit 730 includes a gate driver and a source driver. The display driver circuit 730 drives the liquid crystal panel 740. The power supply circuit 760 supplies power to each circuit.

FIG. 19 is a schematic view showing the main portion of the projection-type display device.

The projection-type display device includes a light source 810, dichroic mirrors 813 and 814, reflection mirrors 815, 816, and 817, an incident lens 818, a relay lens 819, an exit lens 820, liquid crystal light modulators 822, 823, and 824, a cross dichroic prism 825, and a projection lens 826. The light source 810 includes a lamp 811 (e.g., metal halide lamp), and a reflector 812 that reflects light emitted from the lamp. The dichroic mirror 813 that reflects blue/green light allows red light contained in a beam from the light source 810 to pass through, and reflects blue light and green light. Red light that has passed through the dichroic mirror 813 is reflected by the reflection mirror 817, and enters the red light liquid crystal light modulator 822. Green light reflected by the dichroic mirror 813 is reflected by the dichroic mirror 814 that reflects green light, and enters the green light liquid crystal light modulator 823. Blue light also passes through the second dichroic mirror 814. A photo-conductive means 821 formed of a relay lens system including the incident lens 818, the relay lens 819, and the exit lens 820 is provided for blue light in order to prevent optical loss due to a long optical path. Blue light enters the blue light liquid crystal light modulator 824 through the photo-conductive means 821. The three color light rays modulated by each light modulator circuit enter the cross dichroic prism 825. Four rectangular prisms are bonded in the cross dichroic prism 825, and a dielectric multilayer film that reflects red light and a dielectric multilayer film that reflects blue light are formed on the inner side in the shape of a cross. The three color light rays are synthesized by the dielectric multilayer films so that light that represents a color image is formed. The projection means of the projection-type display device is formed as described above. Light synthesized by the projection means is projected onto a screen 827 by a projection lens 826 (projection optical system) so that an enlarged image is displayed.

4.2 Portable Telephone

An electronic instrument formed using the liquid crystal device 10 may be a portable telephone.

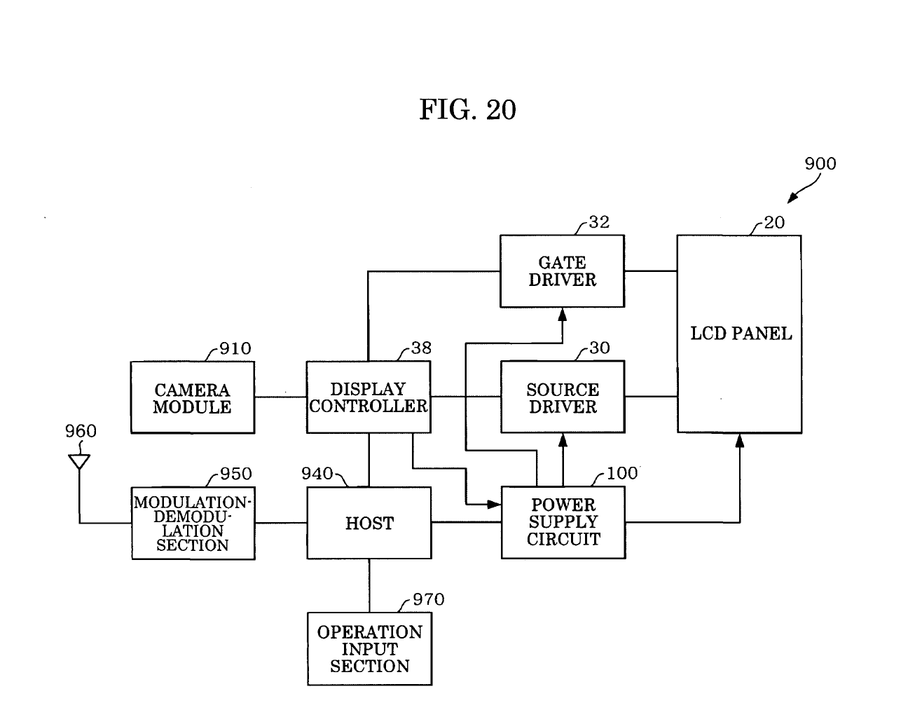

FIG. 20 is a block diagram showing a configuration example of a portable telephone to which the liquid crystal device 10 according to the above-described embodiments is applied. In FIG. 20, the same sections as in FIG. 10 or 11 are indicated by the same symbols. Description of these sections is appropriately omitted.

A portable telephone 900 includes a camera module 910. The camera module 910 includes a CCD camera, and supplies data relating to an image captured using the CCD camera to the display controller 38 in a YUV format.

The portable telephone 900 includes the LCD panel 20. The LCD panel 20 is driven by the source driver 30 and the gate driver 32. The LCD panel 20 includes a plurality of gate lines, a plurality of source lines, and a plurality of pixels.

The display controller 38 is connected to the source driver 30 and the gate driver 32, and supplies grayscale data in an RGB format to the source driver 30.

The power supply circuit 100 is connected to the source driver 30 and the gate driver 32, and supplies drive power supply voltages to the source driver 30 and the gate driver 32. The power supply circuit 100 supplies the common electrode voltage Vcom to the common electrode of the LCD panel 20.

A host 940 is connected to the display controller 38. The host 940 controls the display controller 38. The host 940 demodulates grayscale data received through an antenna 960 using a modulation-demodulation section 950, and supplies the demodulated grayscale data to the display controller 38. The display controller 38 causes the source driver 30 and the gate driver 32 to display an image on the LCD panel 20 based on the grayscale data.

The host 940 modulates grayscale data generated by the camera module 910 using the modulation-demodulation section 950, and instructs transmission of the modulated data to another communication device via the antenna 960.

The host 940 transmits and receives grayscale data, captures an image using the camera module 910, and displays an image on the LCD panel 20 based on operation information from an operation input section 970.

In FIG. 20, the host 940 or the display controller 38 may be referred to as a means that supplies the grayscale data.

Examples of an electronic instrument to which the above-described embodiments or modification may be applied include a personal computer, a personal computer peripheral instrument (e.g., printer, scanner, or complex machine), a portable telephone, a portable information terminal, an audio player, a robot device, a digital camera, a video camera, a GPS device, a television receiver, a projector, and the like.

The invention is not limited to the above-described embodiments. Various modifications and variations may be made without departing from the spirit and scope of the invention. For example, the invention may be applied not only to drive the liquid crystal display panel, but also to drive an electroluminescent display device, a plasma display device, and the like. The liquid crystal panel may be a high-temperature polysilicon liquid crystal panel, a low-temperature polysilicon liquid crystal panel, an amorphous silicon liquid crystal panel, or the like.

Some of the requirements of any claim of the invention may be omitted from a dependent claim that depends on that claim. Some of the requirements of any independent claim of the invention may be allowed to depend on any other independent claim.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A source driver that drives a source line of an electro-optical device, the source driver comprising:
a receiving circuit that receives image data, a vertical synchronization timing, or a horizontal synchronization timing through a transmission line that transmits the image data, the vertical synchronization timing, or the horizontal synchronization timing; and
a source line driver circuit that drives the source line based on the image data in synchronization with the vertical synchronization timing or the horizontal synchronization timing,
the receiving circuit comparing received data that indicates the image data, the vertical synchronization timing, or the horizontal synchronization timing with given vertical synchronization timing designation data or given horizontal synchronization timing designation data; and
the vertical synchronization timing or the horizontal synchronization timing being designated by the received data that coincides with the vertical synchronization timing designation data or the horizontal synchronization timing designation data.

2. The source driver as defined in claim 1,
the source driver including a first counter that starts a count operation after the receiving circuit has detected that the received data coincides with the vertical synchronization timing designation data,
the first counter masking a comparison result between the received data and the vertical synchronization timing designation data until a count value of the first counter reaches a first count value equal to or less than a data reception count value corresponding to a number of scan lines.

3. The source driver as defined in claim 1,
the source driver including a second counter that starts a count operation after the receiving circuit has detected that the received data coincides with the horizontal synchronization timing designation data,
the second counter masking a comparison result between the received data and the horizontal synchronization timing designation data until a count value of the second counter reaches a second count value equal to or less than a data reception count value corresponding to a number of horizontal pixels.

4. The source driver as defined in claim 1,
the vertical synchronization timing being designated using the received data on condition that the received data has successively coincided with the vertical synchronization timing designation data a given number of times.

5. The source driver as defined in claim 1,
the horizontal synchronization timing being designated using the received data on condition that the received data has successively coincided with the horizontal synchronization timing designation data a given number of times.

6. The source driver as defined in claim 1,
data transmitted through the transmission line including an image data field that designates the image data and flag fields that designate the vertical synchronization timing, the horizontal synchronization timing, and parity data.

7. The source driver as defined in claim 6,
the flag fields including an area that designates a command for controlling the source driver.

8. The source driver as defined in claim 1,
the source driver including a vertical synchronization designation data setting register, the vertical synchronization timing designation data being set in the vertical synchronization designation data setting register,
the receiving circuit comparing the received data with a value set in the vertical synchronization designation data setting register.

9. The source driver as defined in claim 1,
the source driver including a horizontal synchronization designation data setting register, the horizontal synchronization timing designation data being set in the horizontal synchronization designation data setting register,
the receiving circuit comparing the received data with a value set in the horizontal synchronization designation data setting register.

10. The source driver as defined in claim 1,
the vertical synchronization timing designation data being data in a super-white area or a super-black area, all bits of the data in the super-white area or the super-black area being “0” or “1”.

11. The source driver as defined in claim 1,
the horizontal synchronization timing designation data being data in a super-white area or a super-black area, all bits of the data in the super-white area or the super-black area being “0” or “1”.

12. An electro-optical device comprising:
a plurality of gate lines;
a plurality of source lines;
a plurality of pixels, each of the plurality of pixels being specified by a corresponding gate line among the plurality of gate lines and a corresponding source line among the plurality of source lines;
a gate driver that scans the plurality of gate lines; and
the source driver as defined in claim 1 that drives the plurality of source lines.

13. An electro-optical device comprising the source driver as defined in claim 1.

14. A projection-type display device comprising:
the electro-optical device as defined in claim 13;
a light source that emits light that enters the electro-optical device; and
projection means that projects light emitted from the electro-optical device.

15. A projection-type display device comprising the source driver as defined in claim 1.

16. An electronic instrument comprising the electro-optical device as defined in claim 13.

17. An electronic instrument comprising:
the electro-optical device as defined in claim 13; and
means that supplies image data to the electro-optical device.

18. An electronic instrument comprising the source driver as defined in claim 1.
